(19) United States
(12) Patent Application Publication
(10) Pub. No.: US 2025/0251304 A1
(43) Pub. Date: Aug. 7, 2025

(54) END-OF-LINE METHOD FOR DETERMINING EFFICIENCY OF A VEHICLE MODULE

(71) Applicant: BorgWarner Sweden AB, Landskrona (SE)

(72) Inventor: Henrik LUNDH, Mellbystrand (SE)

(21) Appl. No.: 18/856,109

(22) PCT Filed: Apr. 13, 2023
(86) PCT No.: PCT/EP2023/059672

§ 371 Date: Oct. 11, 2024

(30) Foreign Application Priority Data
Apr. 13, 2022 (SE) 2250457-5

(51) Int. Cl. G01M 13/021; G01M 13/025

(52) U.S. Cl. CPC G01M 13/021; G01M 13/025

(57) ABSTRACT

A method for measuring mechanical loss in a vehicle module. The vehicle module includes an electric motor, and the method includes controlling the electric motor to run at a specific speed, changing the control of the electric motor to open circuit mode, monitoring an operational parameter associated with the deceleration of the vehicle module, and determining mechanical loss in the vehicle module based on the operational parameter.

### TECHNICAL FIELD

The invention relates in general to a method for determining efficiency of a vehicle module. More specifically, the invention relates to an end-of-line method for determining characteristics associated with mechanical losses in a vehicle module comprising at least an electric motor.

### BACKGROUND

Reducing time to market is one of the most important requirements in the electric vehicle industry. As part of the manufacturing process, the producer must ensure that efficiency is fulfilled for all units delivered from a factory by performing end-of-line (EOL) testing, i.e. testing of the manufactured product at the end of the production line. EOL testing ensures that the unit or manufactured product has been manufactured according to the appropriate specifications, as well as giving an indication of when to start troubleshooting to reduce failure rates.

Standard EOL testing includes measurement of drive specific values for current, voltage, torque and speed to evaluate the test object's efficiency at defined operating points. This can be a complex, unreliable and time consuming task, requiring separate and in many cases uniquely dedicated test equipment, and resulting in a low testing throughput and increased costs. Especially for complex products, e.g. electrical motor modules with built-in gearboxes or similar, available end-of-line testing procedures do not allow for determining mechanical loss of individual sub-modules, such as the built-in gearbox, in an efficient manner.

Thus, there is a need for an improved EOL testing in vehicle modules.

### SUMMARY

An object of the present invention is to solve or at least mitigate the problems related to prior art. This object is achieved by means of the technique set forth in the appended independent claims; preferred embodiments being defined in the related dependent claims.

According to a first aspect, an end-of-line method for measuring mechanical loss in a vehicle module comprising an electric motor is provided. The method comprises controlling the electric motor to run at a specific speed, switching the control of the electric motor to active open mode, monitoring an operational parameter associated with the deceleration of the vehicle module, and determining mechanical loss in the vehicle module based on the operational parameter.

Accordingly, a method for measuring mechanical loss in a vehicle module is provided. The method is designed to be performed in association with the vehicle module at the end of the production line. The vehicle module comprises an electric motor, and the method comprises i) controlling the electric motor to run at a specific speed, ii) changing the control of the electric motor to open circuit mode by leaving the wires of the electric motor open and/or electrically disconnecting the motor phases from a controller, iii) monitoring an operational parameter relating to a rotational speed of the electric motor and associated with the deceleration of the vehicle module, and iv) determining mechanical loss in the vehicle module based on the operational parameter.

The operational parameter may be relating to a rotational speed of the electric motor.

The step of monitoring an operational parameter may comprise determining a characteristic response of the vehicle module.

The characteristic response may relate to at least one of: a speed drop during a predetermined time interval; a derivate of a speed; and/or a time required for reaching a predetermined speed.

The characteristic response comprises a predetermined first time interval and a predetermined second time interval.

The method may further comprise comparing the determined characteristic response with a reference characteristic response.

The electric motor may be connected to a gear assembly via a disconnect coupling, and the method may further comprise, before the step of changing the control of the electric motor to open circuit mode, disconnecting the disconnect coupling.

The steps of controlling the electric motor to run at a specific speed, changing the control of the electric motor to open circuit mode, and monitoring an operational parameter associated with the deceleration of the vehicle module, may be performed as a first test cycle when the disconnect coupling is connected, and as a second test cycle when the disconnect coupling is disconnected, and the method may further comprise determining mechanical loss in the gear assembly based on a comparison between the determined operational parameters.

The electric motor may be connected to a multi-stage gear assembly, and the method may further comprise before the step of changing the control of the electric motor to open circuit mode: shifting the stage of the gear assembly.

The steps of controlling the electric motor to run at a specific speed, changing the control of the electric motor to open circuit mode, and monitoring an operational parameter associated with the deceleration of the vehicle module, may be performed further as a third test cycle when the stage of the gear assembly is shifted, and wherein the method further comprises determining mechanical loss in a specific gear assembly stage based on a comparison between the determined operational parameters.

Generally, all terms used in the claims are to be interpreted according to their ordinary meaning in the technical field, unless explicitly defined otherwise herein. All references to “a/an/the [parameter, characteristic response, step, etc]” are to be interpreted openly as referring to at least one instance of said parameter, characteristic response, step, etc., unless explicitly stated otherwise. The steps of any method disclosed herein do not have to be performed in the exact order disclosed, unless explicitly stated.

### BRIEF DESCRIPTION OF THE DRAWINGS

By way of example, embodiments of the present invention will now be described with reference to the accompanying drawings, in which:

FIGS. 1a-c are flow charts of an end-of-line method according to different embodiments.

FIGS. 2-4 are schematic views of a vehicle module according to different embodiments.

FIG. 5 is a schematic view of a characteristic response resulting from a method according to an embodiment.

### DETAILED DESCRIPTION

The present invention will now be described more fully hereinafter with reference to the accompanying drawings, in which examples of the invention are shown. This invention may, however, be exemplified in many different forms and should not be construed as limited to the examples set forth herein; rather, these examples are provided for thoroughness and completeness, and fully convey the scope of the invention to the skilled person.

It will be appreciated that the present invention is not limited to the embodiments shown. Several modifications and variations are thus conceivable within the scope of the invention which is exclusively defined by the appended claims.

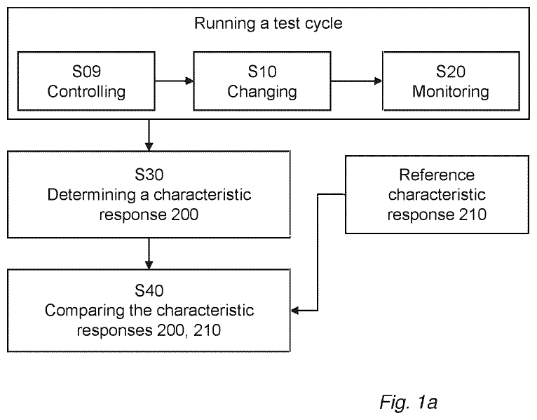

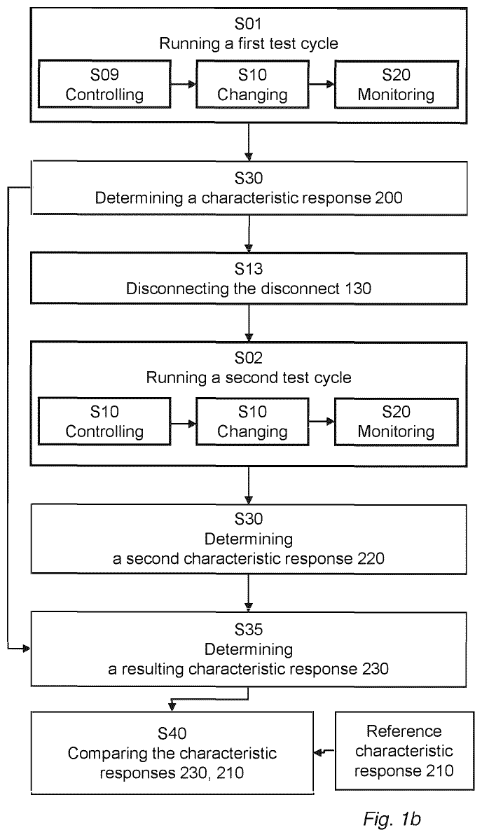

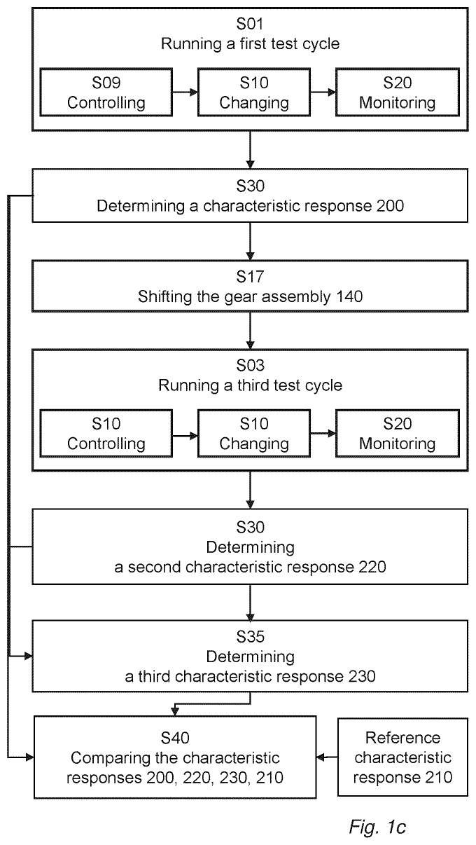

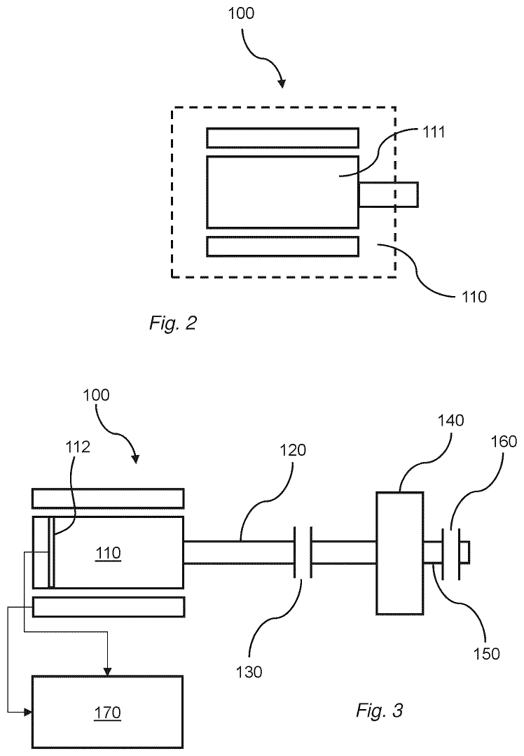

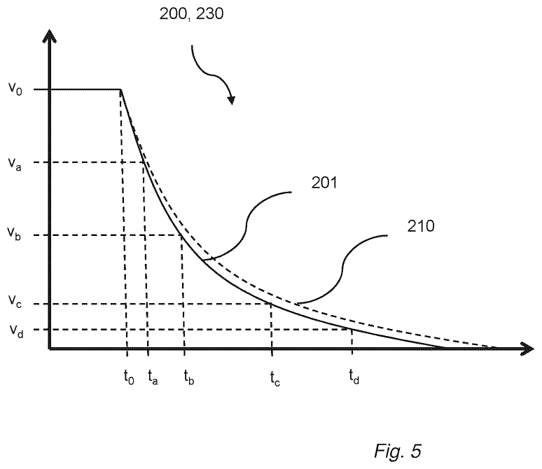

Starting in FIG. 1a an end-of-line method for measuring mechanical loss in a vehicle module 100 (see FIGS. 2-4) according to an embodiment is provided. The vehicle module 100 comprises at least an electric motor 110, as illustrated in FIG. 2. The method according to the embodiment shown in FIG. 1a comprises controlling S09 the electric motor 110 to run at a specific speed v₀, changing S10 the control of the electric motor 110 to open circuit mode, monitoring S20 an operational parameter 201 (see FIG. 5) associated with the deceleration of the vehicle module 100, and determining mechanical loss, as a measure for efficiency, in the vehicle module based on the operational parameter 201.

By the electric motor 110 being run at a specific speed v₀, it is meant that a rotor 111 of the motor 110 is rotating at the specific speed v₀, measured in for instance revolutions per minute, rpm. The step of changing S10 the control of the electric motor 110 to open circuit mode may comprise leaving the wires of the electric motor open and/or electrically disconnecting the motor phases from the controller.

Generally, open circuit mode of the electric motor 110 refers to any situation where the circuit between the power source and the electric motor 110 is interrupted or disconnected. In other words, the electrical path is broken, and no current can flow through the electric motor 110. When the electric motor 110 is in an open circuit mode, it does not receive the necessary electrical energy to perform its normal function.

When the electric motor 110 is changed to open circuit mode, the rotor 111 will continue its rotating movement at a gradually decreasing speed, i.e. coast mode due to its own inertia. The rotational movement of the rotor 111 will in the open circuit mode not be actively driven by the electric motor 110, but rather by inertia of the electric motor 110 and possibly other revolving parts of the vehicle module 100. Braking forces from mechanical loss factors such as friction and splashing will slow down the rotational speed of the rotor 111 further, and increase the deceleration.

The operational parameter 201 may be related to the rotational speed of the electric motor 110. The operational parameter 201 may for instance be motor position, thus speed, measured by means of a position sensor on the rotor 111 of the motor 110.

According to the embodiment shown in FIG. 1a, the step of determining mechanical loss of the vehicle module is performed by determining S30 a characteristic response 200 of the vehicle module 100. An example of such characteristic response 200 is shown in FIG. 5, where the operational parameter 201, being a rotational speed, is plotted against time. As can be seen in FIG. 5, the speed of the electric motor is initially the specific speed vo. By changing S10 the control of the electric motor 110 to open circuit mode, at to in the figure, the speed will decelerate towards zero.

The characteristic response 200 may relate to at least one of: a speed drop during a predetermined time interval, a derivate of a speed, and/or a time required for reaching a predetermined speed. The characteristic response 200 may for instance relate to a speed drop derivate at an interval, or a total time to stop.

The characteristic response 200 may comprise a predetermined first time interval, illustrated in FIG. 5 as tₐ,t_{b} and a predetermined second time interval, t_{c},t_{d}. Different intervals of the characteristic response may relate to different mechanical losses in the vehicle module 100. The speed drop Δv=vₐ−v_{b} or its derivate in the first time interval tₐ,t_{b} may for instance relate to splash losses, and the speed drop Δv=v_{c}−v_{d} of the second time interval, t_{c},t_{d}. may relate to friction of seals and bearings.

Turning back to the embodiment illustrated in FIG. 1a,the method further comprises comparing S40 the determined characteristic response 200 with a reference characteristic response 210 (see FIG. 5). The reference characteristic response 210 may for instance be an ideal characteristic response, or an acceptable characteristic response. The reference characteristic response 210 may for instance be obtained by modeling, or by measurements of a reference vehicle module. The difference between the determined characteristic response 200 and the reference characteristic response 210 may be determined overall, at specific times, or at predetermined intervals, such as the first and second time interval tₐ,t_{b}, t_{c}, t_{d}.

If the determined difference is above an acceptable threshold, the vehicle module 100 may be considered unacceptable as it does not fulfil the end-of-line requirements. If the determined characteristic response 200 deviates at an unacceptable level from the reference characteristic response 201 in the first time interval tₐ,t_{b}, the splash losses may be considered to be unacceptable. If the determined characteristic response 200 deviates at an unacceptable level from the reference characteristic response 201 in the second time interval t_{c},t_{d}, the friction losses may be considered unacceptable.

Advantageously, the mechanical loss of the vehicle module 100 may be measured with a high testing throughput without the need for time consuming tasks or separate test equipment, as the only input parameter needed to determine mechanical losses is the operational parameter, and the operational parameter is easily monitored by signals already available from the electric motor 110.

Turning now to FIG. 1b, an end-of-line method for measuring mechanical loss in a vehicle module 100 according to another embodiment is provided. The vehicle module 100 comprises an electric motor 110 connected to a gear assembly 140 via a disconnect coupling 130, as illustrated in FIG. 3. The method according to the embodiment shown in FIG. 1b further comprises disconnecting S13 the disconnect coupling 130.

The steps of controlling S09 the electric motor 110 to run at a specific speed v₀, changing S10 the control of the electric motor 110 to active open mode, and monitoring S20 an operational parameter 201 associated with the deceleration of the vehicle module 100, may be performed as a first test cycle S01 when the disconnect coupling 130 is connected, and as a second test cycle S02 when the disconnect coupling 130 is disconnected. This will result in a first characteristic response 200 for the entire vehicle module, and a second characteristic response 220 for the vehicle module when the gear assembly 140 is disconnected. The method may further comprise determining a resulting third characteristic response 230 by comparing the already determined characteristic responses 200, 220, and determining the contribution from the components downstream the disconnect coupling 130 (i.e. the gear assembly 140 in the present embodiment). This may e.g. be performed by subtracting the second characteristic response 220 from the first characteristic response 200. From the third characteristic response 230, it is possible to determine the efficiency of the gear assembly 140.

As mentioned previously, the step of monitoring S20 an operational parameter 201 is followed by a step of determining S30 a characteristic response 200 of the entire vehicle module 100 following the first test cycle, and by a step of determining S30 a characteristic response 220 of parts of the vehicle module 100 following the second test cycle. From these two characteristic responses 200, 220, a resulting third characteristic response 230 is determined which is representative of the mechanical loss for the parts of the vehicle module 100 being disconnected during the second test cycle.

In order to determine the end-of-line performance of the disconnectable parts of the vehicle module 100, a comparison between the monitored operational parameters may be performed from the resulting third characteristic response 230, and by comparing this third characteristic response 230 with a reference characteristic response 210, representing the characteristic response 210 of the disconnectable parts of the vehicle module 100 when the mechanical loss is at an acceptable level.

As mechanical losses in a gear assembly 140 typically are small, they are difficult to test with standard EOL equipment within an acceptable time. By performing a first test cycle S01 when the disconnect coupling 130 is connected, and a second test cycle S02 when the disconnect coupling 130 is disconnected, it is facilitated to characterize the efficiency of the gear assembly 140 by looking at the difference 230 in the characteristic responses 200, 220, and by comparing the difference to a reference characteristic response 210. Hence, it is ensured that mechanical losses of the gear assembly 140 are measured in the method of the present invention in order to determine the efficiency of the gear assembly 140.

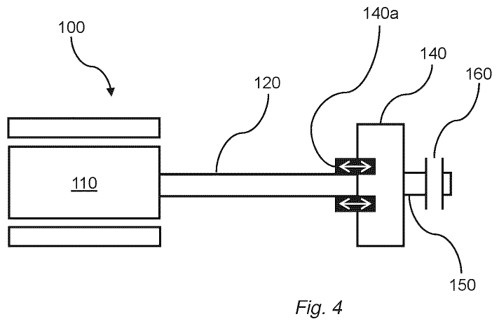

Turning now to FIG. 1c, an end-of-line method for measuring mechanical loss in a vehicle module 100 according to another embodiment is provided. The electric motor 110 is connected to a multi-stage gear assembly 140, as illustrated in FIG. 4. The method according to the embodiment shown in FIG. 1c further comprises shifting S17 the stage of the gear assembly 140 in order to determine the efficiency of separate gear stages of the gear assembly 140.

The multi-stage gear assembly 140 may comprise shifting means 140a, and the step of shifting S17 may be carried out by engaging the shifting means 140a.

The steps of controlling S09 the electric motor 110 to run at a specific speed v0, changing S10 the control of the electric motor 110 to open circuit mode, and monitoring S20 an operational parameter 201 associated with the deceleration of the vehicle module 100, may also be performed further as a third test cycle S03, and possibly further test cycles, when the stage of the gear assembly 140 is shifted. This will result in a first characteristic response 200 for the entire vehicle module when the gear assembly 140 is in a first gear stage, and a second characteristic response 220 for the entire vehicle module when the gear assembly 140 is in a second gear stage. The method may further comprise determining a resulting third characteristic response 230 by comparing the already determined characteristic responses 200, 220, and determining the characteristic response for specific gear stages. This may e.g. be performed by subtracting the second characteristic response 220 from the first characteristic response 200. From the third characteristic response 230, it is possible to determine the efficiency of the second gear stage of the gear assembly 140.

As mentioned previously, the step of monitoring S20 an operational parameter 201 is followed by a step of determining S30 a characteristic response 200 of the entire vehicle module 100 when the gear assembly 140 is in a first gear stage following the first test cycle, and by a step of determining S30 a characteristic response 220 of the entire vehicle module 100 when the gear assembly is in a second gear stage following the second test cycle. From these two characteristic responses 200, 220, a third characteristic response 230 can be determined which is representative of the mechanical loss for the parts of the vehicle module 100 used in the first gear stage, but not used in the second gear stage.

In order to determine the end-of-line performance of the different gear stages of the vehicle module, a comparison between the monitored operational parameters may be performed from the resulting third characteristic response 230, and by comparing this third characteristic response 230 with a reference characteristic response 210. Optionally, each measured characteristic response 200, 220 may be compared individually with one or more reference characteristics 210 in order to determine the efficiency of each gear stage.

The steps of controlling S09, changing S10, and monitoring S20 may be performed further as a fourth test cycle when the stage of the gear assembly is shifted once more, etc. The step of monitoring S20 may be performed by comparing further characteristic responses relating to further monitored stages of the multi-stage gear assembly 140.

Mechanical losses in a multi-stage gear assembly 140 are difficult to test with standard EOL equipment within an acceptable time. By performing a first test cycle S01 when gear assembly 140 is at a certain stage, and as a third test cycle S03 stage of the gear assembly 140 is shifted, it is facilitated to characterize the gear assembly 140 by looking at the difference in the characteristic responses 200, 230, or by comparing the characteristic responses 200, 230 individually. Hence, it is ensured that mechanical losses of the different stages of the multi-stage gear assembly 140 are measured in the method of the present invention.

Although the invention has been described with reference to the specific example shown in the figures, it should be noted that in some embodiments or elements thereof may be combined. For instance, an embodiment of the vehicle module 100, not illustrated, may comprise a disconnect 130 and a multi-stage gear assembly 140.

Similarly, an embodiment of the end-of-line method for measuring mechanical loss in a vehicle module 100, not illustrated, may comprise running a first test cycle S01, a second test cycle S02, and a third test cycle S03. The step of comparing S40 the characteristic responses may refer to any combination of the characteristic responses 200, 210, 220, 230.

As illustrated in FIGS. 3 and 4, the vehicle module 100 may comprise a rotational shaft 120 connected to the electric motor 110. As further illustrated in FIGS. 3 and 4, the vehicle module 100 may comprise a second disconnect 160, connected to an output shaft 150 of the gear assembly 140. Before running a test cycle, the second disconnect 160 may be disconnected such that the disclosed sub-module of the vehicle module 100 is disengaged from other undisclosed sub-modules, and that the rotational movement of the rotor 100 will, in the open circuit mode, be driven by inertia of the disclosed sub-module, comprising the electric motor 110 and possibly the gear assembly 140, only. An advantage of this is that the mechanical loss of the vehicle module 100 may be measured with a high testing throughput without the need for time consuming tasks or separate equipment stations.

As is shown in FIG. 3, the vehicle module 100 is preferably connected to a controller 170 being configured to control the operation of the electric motor 110, i.e. to accelerate the electric motor 110 to an initial specific speed v₀, and to monitor at least one operational parameter associated with the deceleration of the vehicle module 100. For monitoring, the controller 170 may receive speed data from a resolver 112 or any similar device.

The method according to the present invention is applicable but not limited to all electric motors, combined transmissions, integrated drive modules, electric drive modules and hybrid drive applications.

From the description above follows that, although various embodiments of the invention have been described and shown, the invention is not restricted thereto, but may also be embodied in other ways within the scope of the subject-matter defined in the following claims.

1. A method for measuring mechanical loss in a vehicle module comprising an electric motor at an end-of-line of a manufacturing process, the method comprising:
controlling the electric motor to run at a specific speed,
changing the control of the electric motor to an open circuit mode by leaving wires of the electric motor open and/or electrically disconnecting motor phases from a controller,
monitoring an operational parameter associated with a deceleration of the vehicle module, and
determining the mechanical loss in the vehicle module based on the operational parameter.

2. The method according to claim 1, wherein the operational parameter is relating to a rotational speed of the electric motor.

3. The method according to claim 2, wherein monitoring the operational parameter comprises:
determining a characteristic response of the vehicle module.

4. The method according to claim 3, wherein the characteristic response relates to at least one of: a speed drop during a predetermined time interval; a derivate of a speed; and/or a time required for reaching a predetermined speed.

5. The method according to claim 3, wherein the characteristic response comprises a predetermined first time interval and a predetermined second time interval.

6. The method according to claim 5, the method further comprising:
comparing the determined characteristic response with a reference characteristic response.

7. The method according to claim 1, wherein the electric motor is connected to a gear assembly via a disconnect coupling, and wherein the method further comprises before the step of changing the control of the electric motor to open circuit mode:
disconnecting the disconnect coupling.

8. The method according to claim 7, wherein the steps of controlling the electric motor to run at the specific speed, changing the control of the electric motor to the open circuit mode, and monitoring the operational parameter associated with the deceleration of the vehicle module, are performed as a first test cycle when the disconnect coupling is connected, and as a second test cycle when the disconnect coupling is disconnected, and wherein the method further comprises determining the mechanical loss in the gear assembly based on a comparison between the monitored operational parameters.

9. The method according to claim 8, wherein the electric motor is connected to a multi-stage gear assembly, and wherein the method further comprises before the step of changing the control of the electric motor to the open circuit mode:
shifting the a stage of the gear assembly.

10. The method according to claim 9, wherein the steps of controlling the electric motor to run at the specific speed, changing the control of the electric motor to the open circuit mode, and monitoring the operational parameter associated with the deceleration of the vehicle module, are performed further as a third test cycle when the stage of the gear assembly is shifted, and wherein the method further comprises determining the mechanical loss in a specific gear assembly stage based on the comparison between the monitored operational parameters.

11. The method according to claim 1, wherein monitoring the operational parameter comprises:
determining a characteristic response of the vehicle module.

12. The method according to claim 11, wherein the characteristic response relates to at least one of: a speed drop during a predetermined time interval; a derivate of a speed; and/or a time required for reaching a predetermined speed.

13. The method according to claim 11, wherein the characteristic response comprises a predetermined first time interval and a predetermined second time interval.

14. The method according to claim 11, the method further comprising:
comparing the determined characteristic response with a reference characteristic response.

15. The method according to claim 1, wherein the electric motor is connected to a multi-stage gear assembly, and wherein the method further comprises before the step of changing the control of the electric motor to the open circuit mode:
shifting a stage of the gear assembly.

16. The method according to claim 15, wherein the steps of controlling the electric motor to run at the specific speed, changing the control of the electric motor to the open circuit mode, and monitoring the operational parameter associated with the deceleration of the vehicle module, are performed further as a third test cycle when the stage of the gear assembly is shifted, and wherein the method further comprises determining the mechanical loss in a specific gear assembly stage based on a comparison between the monitored operational parameters.
